(19) United States
(12) Patent Application Publication
(10) Pub. No.: US 2013/0081010 A1
(43) Pub. Date: Mar. 28, 2013

(54) TEMPLATE AND SERVER CONTENT DOWNLOAD USING PROTOCOL HANDLERS

(71) Applicants: Curtis John Howell, Kirkland, WA (US); Kyle Matthew von Haden, Bothell, WA (US); Ryan Heaney, Seattle, WA (US); Olivier Destrebecq, Seattle, WA (US); Brandon Philip Zahl, Seattle, WA (US); Kenneth John Yuhas, JR., Seattle, WA (US); Manasi Vinayak Velhankar, Redmond, WA (US)

(72) Inventors: Curtis John Howell, Kirkland, WA (US); Kyle Matthew von Haden, Bothell, WA (US); Ryan Heaney, Seattle, WA (US); Olivier Destrebecq, Seattle, WA (US); Brandon Philip Zahl, Seattle, WA (US); Kenneth John Yuhas, JR., Seattle, WA (US); Manasi Vinayak Velhankar, Redmond, WA (US)

(73) Assignee: MICROSOFT CORPORATION, Redmond, WA (US)

(21) Appl. No.: 13/240,494

(22) Filed: Sep. 22, 2011

(51) Int. Cl. G06F 9/44; G06F 15/16

(52) U.S. Cl. 717/173

(57) ABSTRACT

A protocol handler that is registered to handle URLs that follow a protocol that is associated with a client application initiates content downloads from a network location. When a Uniform Resource Locator (URL) is selected from a browser, the protocol handler passes the URL to the client application registered to handle the protocol. The client application parses the URL and determines the actions to perform based on the content identified in the URL. A client application may perform many different actions, such as: downloading the identified content; downloading any additional content (e.g. related files) associated with the identified content; place the downloaded content on a clipboard; automatically display downloaded content within a display; and the like. When the application is not installed on the client machine, information may be provided to the user to assist in interacting with the content identified by the URL.

### BACKGROUND

A user can access and view many types of electronic documents using a Web browser. For some types of electronic documents, however, Web browsers are incapable of rendering the documents without the use of additional software. For example, for electronic documents that are not natively supported by a Web browser, a “plug-in” program may sometimes be utilized in conjunction with the Web browser to enable viewing of the documents. These plug-ins, however, are developed for use with a particular brand of Web browser. Not only does the user need to have the correct plug-in installed to view the non-native content, a plug-in developed for the type of Web browser the user is using has to have been developed. As a result, a plug-in may be unavailable or incompatible with the Web browser application utilized by the user.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A protocol handler that is registered to handle URLs that follow a protocol that is associated with a client application initiates content downloads from a network location. When a Uniform Resource Locator (URL) is selected from a browser, the protocol handler passes the URL to the client application registered to handle the protocol. The client application parses the URL and determines the actions to perform based on the content identified in the URL. A client application may perform many different actions, such as: downloading the identified content; downloading any additional content (e.g. related files) associated with the identified content; place the downloaded content on a clipboard; automatically display downloaded content within a display; and the like. For example, a URL may identify a template that the client application displays and/or an image may be identified that is automatically placed in a document and/or on the clipboard. When the application is not installed on the client machine, information may be provided to the user to assist in interacting with the content identified by the URL.

### BRIEF DESCRIPTION OF THE DRAWINGS

FIG. 1 illustrates an exemplary computing device;

FIG. 2 illustrates an exemplary system for a client application downloading content using a protocol handler;

FIG. 3 shows a process for registering a protocol and installing a protocol handler;

FIG. 4 shows a process for a client application downloading content in response to receiving a link;

FIG. 5 shows a process for downloading related content to content identified by the link; and

FIG. 6 shows a process for storing a downloaded image on a clipboard.

### DETAILED DESCRIPTION

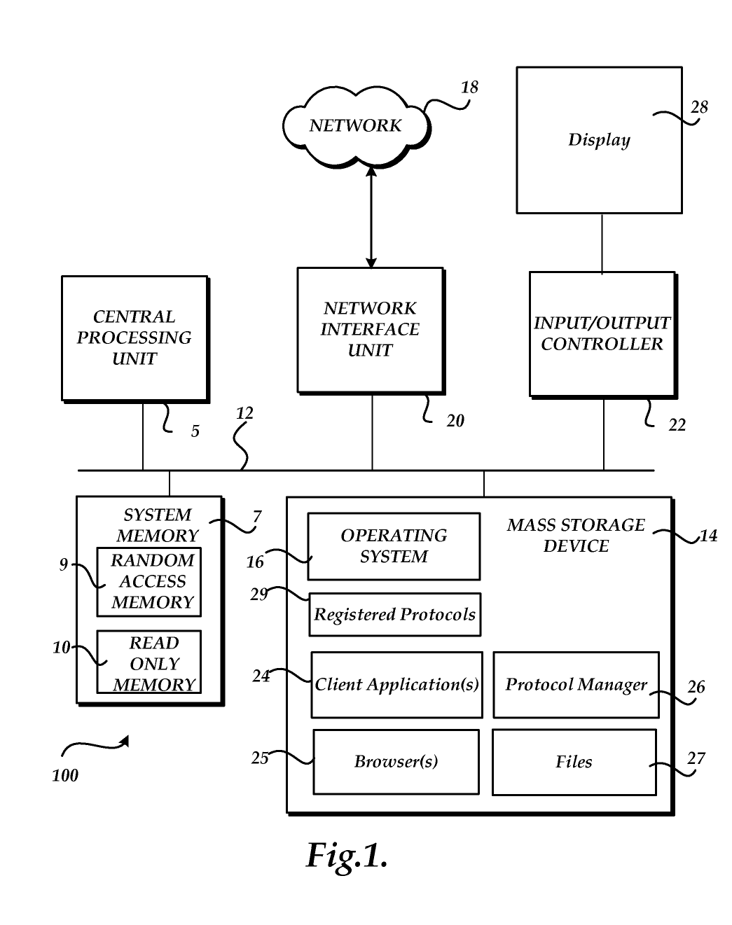

Referring now to the drawings, in which like numerals represent like elements, various embodiments will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer architecture for a computer 100 utilized in the various embodiments will be described. The computer architecture shown in FIG. 1 may be configured as a mobile computing device (e.g. smartphone, notebook, tablet . . . ) or desktop computer and includes a central processing unit 5 (“CPU”), a system memory 7, including a random access memory 9 (“RAM”) and a read-only memory (“ROM”) 10, and a system bus 12 that couples the memory to the central processing unit (“CPU”) 5.

A basic input/output system containing the basic routines that help to transfer information between elements within the computer, such as during startup, is stored in the ROM 10. The computer 100 further includes a mass storage device 14 for storing an operating system 16, client application(s) 24, and other program modules, such as one or Web browser applications 25, files 27 (e.g. files, images, other content), registered protocols 29 and protocol manager 26 which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, Erasable Programmable Read Only Memory (“EPROM”), Electrically Erasable Programmable Read Only Memory (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

According to various embodiments, computer 100 may operate in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, such as a touch input device. The touch input device may utilize any technology that allows single/multi-touch input to be recognized (touching/non-touching). For example, the technologies may include, but are not limited to: heat, finger pressure, high capture rate cameras, infrared light, optic capture, tuned electromagnetic induction, ultrasonic receivers, transducer microphones, laser rangefinders, shadow capture, and the like. According to an embodiment, the touch input device may be configured to detect near-touches (i.e. within some distance of the touch input device but not physically touching the touch input device). The touch input device may also act as a display 28. The input/output controller 22 may also provide output to one or more display screens, a printer, or other type of output device.

A camera and/or some other sensing device may be operative to record one or more users and capture motions and/or gestures made by users of a computing device. Sensing device may be further operative to capture spoken words, such as by a microphone and/or capture other inputs from a user such as by a keyboard and/or mouse (not pictured). The sensing device may comprise any motion detection device capable of detecting the movement of a user. For example, a camera may comprise a MICROSOFT KINECT® motion capture device comprising a plurality of cameras and a plurality of microphones.

Embodiments of the invention may be practiced via a system-on-a-chip (SOC) where each or many of the components/processes illustrated in the FIGURES may be integrated onto a single integrated circuit. Such a SOC device may include one or more processing units, graphics units, communications units, system virtualization units and various application functionality all of which are integrated (or “burned”) onto the chip substrate as a single integrated circuit. When operating via a SOC, all/some of the functionality, described herein, with respect to the Unified Communications via application-specific logic integrated with other components of the computing device/system 100 on the single integrated circuit (chip).

As mentioned briefly above, a number of program modules and data files may be stored in the mass storage device 14 and RAM 9 of the computer 100, including an operating system 16 suitable for controlling the operation of a networked personal computer, such as the WINDOWS 7® operating system from MICROSOFT CORPORATION of Redmond, Wash. According to an embodiment, the operating system is configured to support registered protocols 29 that are associated with one or more client applications 24. For example, a different protocol may be associated with each of the different client applications. According to an embodiment, each client application within a productivity suite of applications is associated with a different protocol. A URL included within a web page (or some other location) may use the protocol to provide the client application with information on what actions to perform/content to download.

The mass storage device 14 and RAM 9 may also store one or more program modules. In particular, the mass storage device 14 and the RAM 9 may store one or more client applications 24, such as productivity applications, and may store one or more Web browsers 25. The Web browser 25 is operative to request, receive, render, and provide interactivity with electronic documents, such as a Web page that has been formatted using HTML. According to an embodiment, the Web browser comprises the INTERNET EXPLORER Web browser application program from MICROSOFT CORPORATION. It should be appreciated, however, that other Web browser application programs from other manufacturers may be utilized to embody the various aspects of the present invention, such as the FIREFOX Web browser application from the MOZILLA FOUNDATION.

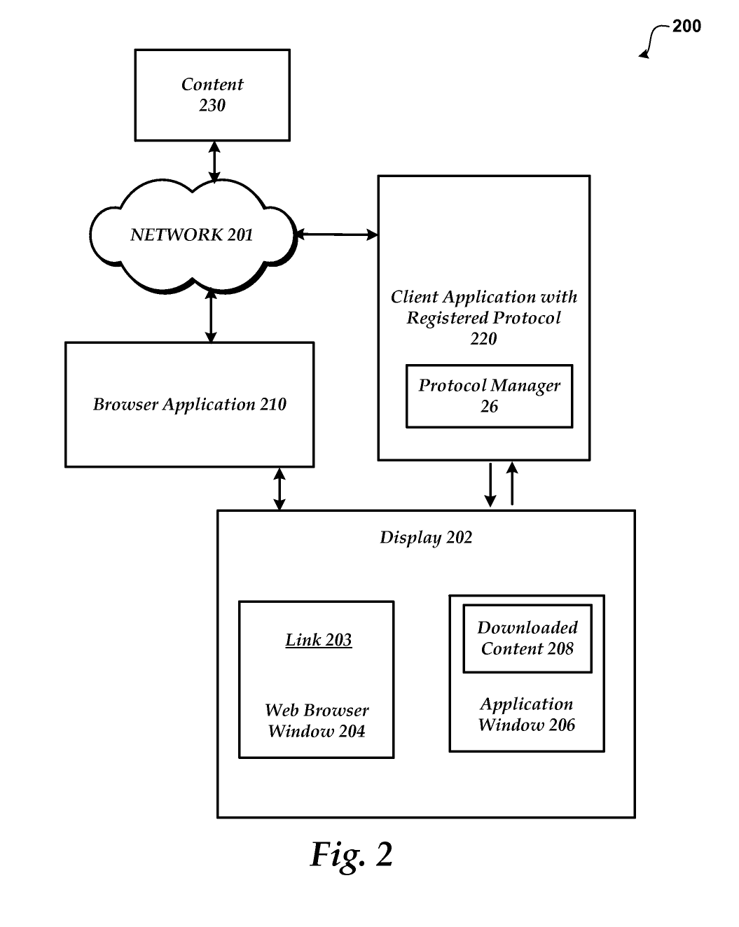

In conjunction with the operation of one or more client applications, protocol manager 26 is used to process URLs that follow a protocol that is associated with a client application. The functionality of protocol manager 26 may be external to client application 24 as illustrated or included with the functionality of a client application (See FIG. 2). Additional details regarding the operation of protocol manager 26 will be provided below.

FIG. 2 illustrates an exemplary system for a client application downloading content using a protocol handler. As illustrated, system 200 includes client application 220 that is associated with a registered protocol, protocol manager 26, browser application 210, display 202, network 201 and content 230.

In order to facilitate communication with the protocol manager 26, one or more callback routines, may be implemented. According to an embodiment, client application 220 is one or more productivity applications, such as associated with the MICROSOFT OFFICE suite of applications.

Browser application 210 is a Web browser that is operative to request, receive, render, and provide interactivity with electronic documents, such as a Web page that has been formatted using HTML and is displayed within window 204. According to an embodiment, the Web browser comprises the INTERNET EXPLORER Web browser application program from MICROSOFT CORPORATION. Other browser applications may be used. Browser application may display pages that include links that follow one/more protocols. The protocols may be specific to a client application. The browser application 210 may also include one or more plug-ins. According to an embodiment, the browser application includes a plug-in that provides information specifying that a client application for a registered protocol is installed. The browser may use this information to determine when/when not to display a link that follows a registered protocol. While many plug-ins for a Web browser are designed to download and interact with content that is associated with a non-native format, the use of a plug-in can be limiting. For example, it may take a considerable amount of time to download and install the plug-in. Further, since plug-ins are typically written for use with a particular brand of Web browser, a plug-in may be unavailable or incompatible with the Web browser application utilized by the user. Additionally, the plug-in may only provide a limited subset of functionality as the application (e.g. the ability to view the content). Even when the plug-in allows the user the ability to interact with and edit the content, the interaction and editing environment does not match the functionality of the client application program. Still yet, a different plug-in has to be developed for each different brand of Web browser.

As illustrated, a web browser window 204 is displayed on display 202 that includes one or more links to content, such as link 203, that is associated with a registered protocol. According to an embodiment, the protocol is registered with the operating system by the client application when the client application is installed. The protocol may be registered at different times. For example, the protocol may be registered before/after the installation of the client application.

Protocol manager 26 is configured to process URLs that follow a protocol that is associated with a client application initiates content downloads from a network location. When a Uniform Resource Locator (URL), such as link 203, is selected from a browser window 204, the protocol handler matching the protocol for the link passes the URL to the client application 220 registered to handle the protocol. According to an embodiment, a time difference between each invocation of the protocol handler and/or selection of a link is calculated to determine if there is a potential security/resource issue. For example, if enough instances of the client application are launched in response to selection of a link or the client application is launched in quick succession, the entire system may become unresponsive. In some instances, the repeated selection of the link(s) that cause the protocol handler to invoke the client application may be a malicious attack on the system. When the time difference falls below a predefined threshold (e.g. 1, 2, 5, 10 seconds), then it is likely that the protocol handler is being repeatedly invoked with malicious intent. When the time difference is below the predefined threshold, the protocol hander does not immediately invoke the client application, stops performing any further action as indicated by the commands encoded in the URL, and displays a dialog asking the user if they would like to continue. According to an embodiment, when the time difference falls below a predefined threshold, the URL is disabled for a period of time before it may be selected again.

Client application 220 and protocol manager 26 parse the link and determines the actions to perform based on the content identified in the link. The client application 220 may perform many different actions, such as: downloading the identified content in the link; determining related files to download, downloading the related files associated with the identified content; storing the downloaded content on a clipboard and/or some other location; automatically displaying downloaded content within a display of the client application; and the like. For example, link 203 may identify a template that the client application uses to determine the related files that are associated with the template. The link may specify some other type of content that is associated with the application. For example, the link may specify an image that is used to identify an image that is of a different quality from an image identified by the link (e.g. higher resolution). The client application may download the content, such as an image, and automatically place the downloaded content on the clipboard. In this way, the content is accessible to the client application and/or other applications. The client application may also download the content, such as an image, and place the downloaded content directly into a pre-existing document and/or a new document. For example, a user may locate an image within an in-application image search that needs to be purchased before the user can include the image within a document. Once the image is purchased, the protocol handler may instruct the application to download the purchased image and place it into a document, such as where the user initialized the process to include the image.

When the application that is associated with the protocol of the link is not installed on the client machine, the browser 210 may display information to the user to assist in interacting with the content identified by the URL. For example, the browser could provide help assistance and/or provide information on how to install the client application that is associated with the protocol. In some cases, the selected URL may reference a different version of the client application than what is installed on the computing device. For example, the URL may reference Client Application Version 5 but only Client Application Version 4 is installed. The selected URL may have behavior defined that is not understandable to the installed version. According to an embodiment, the protocol manager extracts the parts of the selected URL that the installed client application does understand and performs the actions based on the parts that are compatible with the installed version of the client application, while ignoring the pieces of the selected URL that the installed client application does not understand. The protocol manager may also perform other actions when the installed client application does not understand the URL. For example, it may present an option for the user to upgrade to the version of the application.

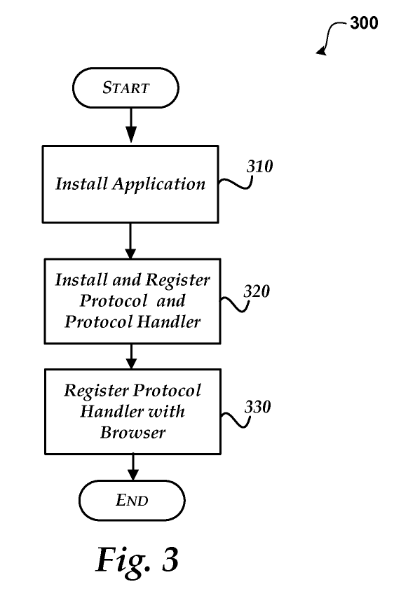

FIGS. 3-6 show illustrative processes for processing a URL that is associated with a protocol for the client application. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

FIG. 3 shows a process for registering a protocol and installing a protocol handler.

After a start operation, the process flows to operation 310, where a client application is installed. The client application may be any type of application. For example, the client application may be a word processing application, a presentation application, a spreadsheet application, and the like.

Moving to operation 320, a protocol and protocol handler for the application is installed and registered. According to an embodiment, the protocol is registered with the operating system. The protocol is configured to provide a description for how a client application is to process information that is contained within a link. For example, the link may be included within a web browser that when selected by a user instructs a client application to obtain not only an item directly specified by the link but also additional related content.

Flowing to operation 330, the protocol handler is registered with a browser. According to an embodiment, a browser plug-in(s) is installed that is used by the browser to determine that a client application is installed on the client device that is registered to handle the protocol. According to another embodiment, the browser may be configured to register a protocol handler without installing a plug-in. For example, a function provided by an API that is associated with a browser may be called to register the protocol handler with the browser. Once registered, the browser is aware that an application is installed on the client device to handle the protocol. According to an embodiment, a link that is associated with a protocol is displayed in response to the browser determining that the protocol is supported by an installed client application.

The process then moves to an end operation and returns to processing other actions.

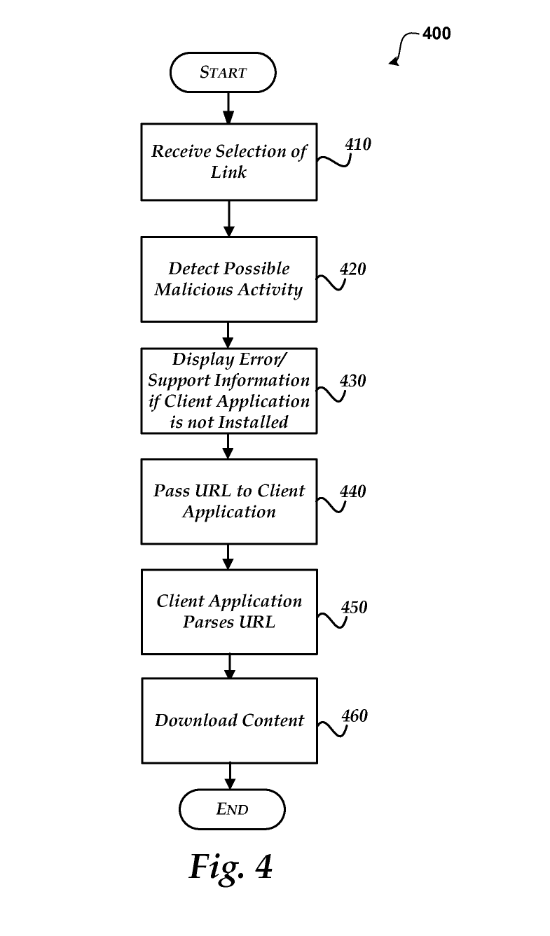

FIG. 4 shows a process for a client application downloading content in response to receiving a link.

After a start operation, the process flows to operation 410, where a link is selected. Generally, the link is selected from within a display of Web page as shown by a browser. The link may be shown in other windows. For example, the link may be displayed in a window of another application that does not include the functionality to process the link.

Flowing to operation 420, possible malicious activity is detected. According to an embodiment, a time difference between each invocation of the protocol handler is calculated to determine if there is a potential security/resource issue. When the time difference falls below a predefined threshold (e.g. 1, 2, 5, 10 seconds), then it is likely that the protocol handler is being repeatedly invoked with malicious intent. When the time difference is below the predefined threshold, the protocol hander does not immediately invoke the client application, stops performing any further action as indicated by the commands encoded in the URL, and displays a dialog asking the user if they would like to continue. According to an embodiment, when the time difference falls below a predefined threshold, the URL is disabled for a period of time before it may be selected again.

Moving to operation 430, an error/support information may be displayed if the client application is not installed to process the link. For example, the browser application may display an error indicating that the client application is not available to process the URL. A help page may also/alternatively be displayed.

Transitioning to operation 440, the URL that is associated with the protocol is passed to the client application. According to an embodiment, the URL is passed by the operating system of the client device to the client application.

Flowing to operation 450, the client application parses the URL to determine the actions to perform and the content to download. The client application uses its functionality to determine the actions to perform. A client application may perform many different actions, such as: downloading the identified content; downloading any additional content (e.g. related files) associated with the identified content; place the downloaded content on a clipboard; place the downloaded content directly within a pre-existing/new document; automatically display downloaded content within a display; and the like. For example, a URL may identify a template that the client application that includes five different related files to download. The client application may also use its functionality to determine where to store the downloaded content. For example, the client application may have a default network location to store content of a particular type (e.g. within a cloud based service and/or some other network location).

Transitioning to operation 460, the content is downloaded from one or more locations.

The process then moves to an end operation and returns to processing other actions.

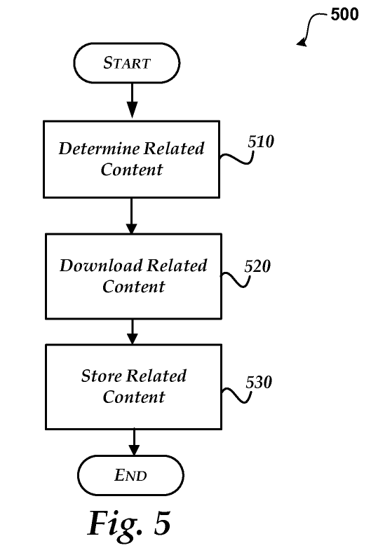

FIG. 5 shows a process for downloading related content to content identified by the link.

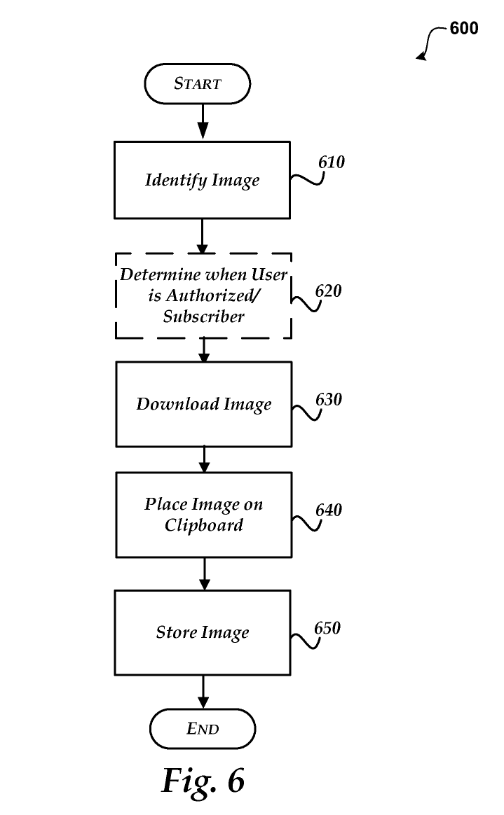

After a start operation, the process flows to operation 510, where the client application determines related content to the content that is directly identified by the link. Instead of accessing and downloading just the content that is directly identified by the link, the client application uses its functionality to determine other related content to download. For example, when the identified content is a template, the client application may determine that the template is associated with four other files that are to be downloaded for the identified template to work properly. The related content may be other files and/or a different version of a file. When the identified content is an image, the related content may be a higher/lower resolution version of the image (See FIG. 6 and related discussion).

Moving to operation 520, the content determined to be related to the identified content within the link is downloaded.

Flowing to operation 530, the related content that is downloaded is stored. The downloaded content may be stored in one or more locations. According to an embodiment, a copy of the content is stored on a clipboard such that the downloaded content may be easily accessed from the client application and/or other applications. The downloaded content may also be stored at a designated location (e.g. on the client device and/or at a network location).

The process then moves to an end operation and returns to processing other actions.

FIG. 6 shows a process for storing a downloaded image on a clipboard.

After a start operation, the process flows to operation 610, where the client application identifies the image specified by the link. For example, a name of the image may be used for identification and/or a location of the image.

Moving to operation 620, the client application may check to determine whether the user is authorized to download the identified image and/or a different version of the image. For example, the client application may determine that the user has subscribed to receive premium images that allow the user to download richer content. In response to selecting a link specifying the low resolution version of the image, the client application may automatically download a higher resolution of the image.

Flowing to operation 630, the determined image to download is downloaded.

Transitioning to operation 640, a copy of the downloaded content is stored on a clipboard such that the downloaded content may be easily accessed from the client application and/or other applications.

Moving to operation 650, the related content that is downloaded is stored. The downloaded content may be stored in one or more locations. For example, the downloaded content may be stored at a designated location (e.g. on the client device and/or at a network location).

The process moves to an end operation and returns to processing other actions.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for interacting with content at a web location, comprising:
receiving a selection of a link within a browser that is associated with a protocol that is registered with an operating system of a client device and associated with an application;
passing the link that is associated with the protocol to the application;
parsing the link using the application; and
automatically performing actions comprising downloading content that is identified by the link using the application.

2. The method of claim 1, wherein the protocol is registered with the operating system when the application is installed on the client device.

3. The method of claim 2, wherein the browser determines when the application is installed on the client device before passing the link that is associated with the protocol to the application.

4. The method of claim 1, further comprising using functionality included with the installed application to determine additional content to be downloaded in addition to the content identified by the link.

5. The method of claim 1, further comprising determining when the link references functionality provided by a different version of the application and providing only references within the link that are supported by the application.

6. The method of claim 1, further comprising the application downloading an image identified by the link and placing the downloaded image in at least one of the following locations: on a clipboard of the client device; within a new document; within a pre-existing document.

7. The method of claim 1, further comprising determining a time difference between a last selection of a link and based on when the time difference is below a predetermined threshold, suspending the passing of the link that is associated with the protocol to the application.

8. The method of claim 1, further comprising displaying a help article when the selection of the link is not handled by the application.

9. The method of claim 1, wherein a browser is informed that the application is installed on the client device that is associated with the protocol.

10. The method of claim 9, further comprising displaying the link within a web page for selection when the information provided by the plug-in indicates that the application is installed on the client device.

11. A computer-readable medium having computer-executable instructions for interacting with content at a web location, comprising:
receiving a selection of a link within a browser that is associated with a protocol that is registered with an operating system of a client device and associated with an application;
determining when the application is installed on the client device before passing the link that is associated with the protocol;
parsing the link using the application; and
automatically downloading content that is identified by the link and using functionality of the application to determine different content to download based on the content identified by the link.

12. The computer-readable medium of claim 11, further comprising the application determining to download additional template related files when the content identified by the link is a template.

13. The computer-readable medium of claim 11, further comprising the application downloading an image identified by the link and placing the downloaded image in at least one of: on a clipboard of the client device; within a new document; within a pre-existing document.

14. The computer-readable medium of claim 13, wherein a higher resolution image is downloaded by the application in place of downloading a displayed image that is shown with a display of the link when a subscription to access the higher resolution image for the user exists.

15. The computer-readable medium of claim 11, further comprising displaying a help article when the selection of the link is not handled by the application.

16. The computer-readable medium of claim 11, further comprising displaying the link within a web page for selection when information provided by a browser indicates that the application is installed on the client device.

17. A system for interacting with content at a web location, comprising:
a display;
a processor and a computer-readable medium;
an operating environment stored on the computer-readable medium and executing on the processor; and
a protocol manager operating under the control of the operating environment and operative to: receiving a selection of a link within a browser that is associated with a protocol that is registered with an operating system of a client device and associated with an application;
determining when the application is installed on the client device before passing the link that is associated with the protocol;
parsing the link using the application; and
automatically downloading content that is identified by the link and using functionality of the application to determine different content to download based on the content identified by the link.

18. The system of claim 17, further comprising the application determining to download additional template related files when the content identified by the link is a template.

19. The system of claim 17, further comprising the application downloading an image identified by the link and placing the downloaded image in one of: on a clipboard of the client device; within a new document; within a pre-existing document.

20. The system of claim 17, wherein a higher resolution image is downloaded by the application in place of downloading an image that is identified by the link.
